(19) United States
(12) Patent Application Publication
(10) Pub. No.: US 2011/0098168 A1
(43) Pub. Date: Apr. 28, 2011

(54) Manufacturing Machine Assembly And Method For Producing Coupon Cards Having Non-Tacky Mini-Coupons

(75) Inventors: Scott D. Best, Troy, MI (US); James F. Turner, Farmington Hills, MI (US)

(73) Assignee: SAXON, INC., Ferndale, MI (US)

(21) Appl. No.: 12/910,312

(22) Filed: Oct. 22, 2010

Related U.S. Application Data
(60) Provisional application No. 61/253,986, filed on Oct. 22, 2009.

(51) Int. Cl. B31B 1/88

(52) U.S. Cl. 493/320

(57) ABSTRACT

A manufacturing machine assembly for producing a coupon card fabricated from a continuous sheet of material. An application station receives the sheet of material with a bottom side facing upward for applying a masking agent to a portion of the bottom side. A drying station dries the masking agent as the sheet of material moves through the drying station at a high rate of speed. An inverting device rotates and reorients the sheet of material such that the top side of the sheet material is facing upward. A printing station prints indicia in parallel rows on the top side for defining a first strip and a second strip. The first and second strips are separated from one another and are bonded together to form a series of two-sided coupon cards. The series of two-sided coupon cards are separated from a web of scrap material to form individual two-sided coupon cards.

### CROSS-REFERENCE TO RELATED APPLICATIONS

The subject patent application claims priority to and all the benefits of U.S. Provisional Patent Application Ser. No. 61/253,986 which was filed on Oct. 22, 2009, the entire specification of which is expressly incorporated herein by reference.

### BACKGROUND

1. Field of the Invention

The present invention relates to a manufacturing machine assembly for producing a coupon card. More particularly, the present invention relates to a manufacturing machine for producing a two-sided coupon card having non-tacky mini-coupons fabricated from a continuous sheet of material.

2. Description of the Related Art

Coupon cards having a number of mini-coupons which may be removed and redeemed are well known. The mini-coupons are a popular means of attracting customers and encouraging additional sales. The prior art coupon cards and mini-coupons have various constructions and are used for a multitude of applications. The prior art coupon cards have a number of deficiencies. Primarily, the mini-coupons are attached to a thin layer of laminated paper such that the coupon cards lack structural integrity once the mini-coupon is removed. Upon removal of a mini-coupon, the laminated paper backing is structurally insufficient for a card that will be repeatedly used. In particular, the coupon cards will be bent repeatedly with each removal of the mini-coupons which weakens the bond between the laminated paper and the remaining mini-coupons. Additionally, the coupon cards are prone to bend and fold undesirably.

Another coupon card in the art, which was designed and developed by the assignee of the subject patent application, has a structure comprising two layers of stock with a liner disposed between the layers of stock. The liner has a first side and a second side opposite the first side. An adhesive layer is disposed on each of the first and second sides of the liner for coupling the liner to each of the layers of stock. The two layers of stock allow the mini-coupons to be removed while allowing the remaining portion of the coupon card to maintain sufficient integrity and rigidity. The mini-coupons are mounted to one side of the coupon card. Informational messages, advertisements, and the like are printed on the opposite side of the coupon card.

The preferred design for the prior art coupon card is to have the mini-coupons disposed on one side of the coupon card such that some integrity of the card is retained as the mini-coupons are removed. Typically, when the mini-coupon cards are removed from the coupon card, one of the adhesive layers are exposed. With the adhesive layer is exposed, a tacky surface is typically present on the mini-coupon. Although useful in certain situations, having the tacky surface exposed can be undesirable in other circumstances.

Another important commercial aspect relative to the coupon cards is the method in which they are manufactured. In order to produce a coupon card that is economically feasible, it is advantageous to quickly and efficiently manufacture the coupon cards using a high-speed manufacturing machine that eliminates any manual intervention during manufacture of the cards.

Accordingly, for certain circumstances it is desirable to develop a coupon card without an exposed tacky surface and method of manufacturing the coupon cards that is fast and efficient.

### SUMMARY OF THE DISCLOSURE

The invention includes a manufacturing machine assembly for producing a coupon card fabricated from a continuous sheet of material including a stock layer having an inner surface and an outer surface, a liner having an interior surface and an exterior surface, and an adhesive layer disposed between the stock layer and the liner for coupling the inner surface of the stock layer to the interior surface of the liner. The stock layer defines a top side and the liner defines a bottom side of the continuous sheet of material. The continuous sheet of material also includes a masking agent. The manufacturing machine assembly comprises a support frame for supporting the continuous sheet of material as the sheet of material moves through the manufacturing machine assembly. An application station is coupled to the support frame. The application station receives the continuous sheet of material with the bottom side facing upward for applying the masking agent to at least a portion of the bottom side of the continuous sheet of material. A drying station is disposed adjacent the application station for drying the masking agent as the sheet of material moves through the drying station at a high rate of speed. An inverting device is also coupled to the support frame for rotating and reorienting the continuous sheet of material such that the top side of the continuous sheet material is facing upward. A printing station prints indicia on the top side of the continuous sheet of material.

The invention also includes an associated method of manufacturing the coupon card. The method comprises the steps of: orienting the continuous sheet of material such that the exterior surface of the liner is facing upward and the outer surface of the stock layer is facing downward; applying the masking agent to at least a portion of the exterior surface of the liner; drying the masking agent; inverting the continuous sheet of material such that the outer surface of the stock layer is facing upward and the exterior surface of the liner is facing downward; printing indicia on the outer surface of the stock layer in two parallel rows to define a first strip having a first adhesive layer, and a second strip having a second adhesive layer; separating the first strip and the second strip; removing the liner from the second strip to expose the second adhesive layer; inverting the second strip relative to the first strip such that second adhesive layer faces the masking agent disposed on the liner of the first strip; mating the second adhesive layer with the masking agent disposed on the liner of the first strip to bond the first strip and the second strip to one another and form a series of two-sided coupon cards such that the first strip defines a first side of the series of two-sided coupon cards and the second strip defines a second side of the series of two-sided coupon cards; cutting completely through the series of two-sided coupon cards to define individual two-sided coupon cards and a web of scrap stock; and removing the web of scrap stock from the individual coupons cards.

Accordingly, the manufacturing machine outlined above provides a fast and efficient method of producing a two-sided coupon card and a method of preventing an exposed tacky surface when the mini-coupons are removed from the coupon card.

### BRIEF DESCRIPTION OF THE DRAWINGS

Advantages of the present invention will be readily appreciated as the same becomes better understood by reference to the following detailed description when considered in connection with the accompanying figures.

FIG. 1A is a fragmentary schematic view of a manufacturing machine assembly of the subject invention illustrating various forward stations.

FIG. 1B is a fragmentary schematic view of a manufacturing machine assembly of the subject invention illustrating various rearward stations.

FIG. 2 is an exploded cross-sectional view taken along line 2-2 of FIG. 1A.

FIG. 3 is a fragmentary top view taken along line 3 of FIG. 1A.

FIG. 4 is a fragmentary perspective view of a cutting device.

FIG. 5 is a cross-sectional view taken along line 5-5 of FIG. 1A.

FIG. 6 is a fragmentary perspective view of a second inverting device.

FIG. 7 is a cross-sectional view taken along line 7-7 of FIG. 1B.

FIG. 8 is a planar bottom view taken along line 8 of FIG. 1B.

FIG. 9 is a cross-sectional view of a two-sided coupon card of a first embodiment illustrating a score line for defining a perimeter of a mini-coupon.

FIG. 9A is a cross-sectional view of the two-sided coupon card of the first embodiment illustrating the mini-coupon removed from the coupon card.

FIG. 10 is a cross-sectional view of a two-sided coupon card of a second embodiment illustrating a score line for defining a perimeter of a mini-coupon.

FIG. 10A is a cross-sectional view of the two-sided coupon card of the second embodiment illustrating the mini-coupon removed from the coupon card.

### DETAILED DESCRIPTION OF THE INVENTION

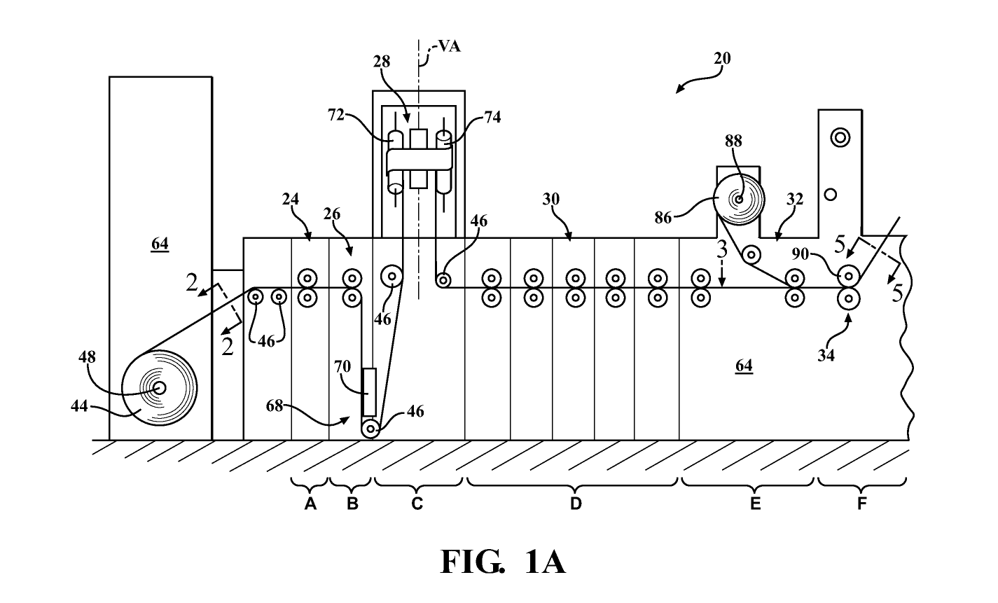

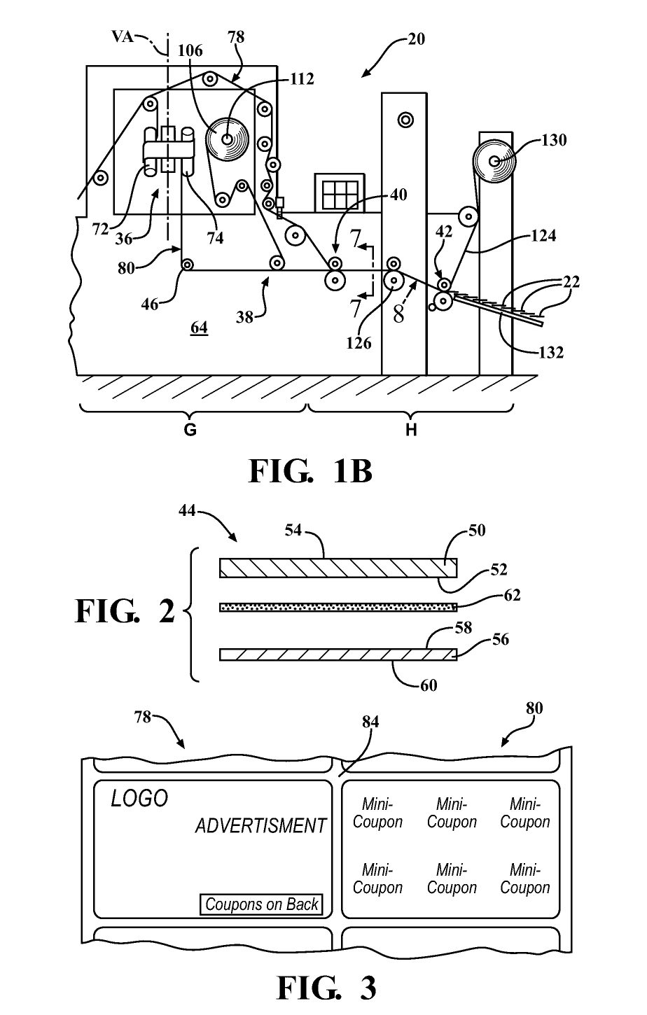

Referring to the figures, wherein like numerals indicate like or corresponding parts throughout the several views, a manufacturing machine assembly for producing a plurality of individual two-sided coupon cards 22 is generally shown at 20 in FIGS. 1A and 1B. Specifically, FIG. 1A discloses a series of various forward stations of the manufacturing machine assembly 20 and FIG. 1B discloses a series of various rearward stations of the manufacturing machine 20. The manufacturing machine assembly 20 may be divided into a plurality of separate sections with each of the sections having one or more stations. Section A includes an initial printing station 24 and Section B includes an application station 26. Section C includes a first inverting device 28, section D includes a plurality of primary printing stations 30, and Section E includes a laminating device 32. Section F includes a cutting device 34 and Section G includes a second inverting device 36 and a stripping device 38. Section H includes a pair of oppositely disposed coupling rollers 40 and a pair of oppositely disposed forming rollers 42.

A continuous sheet of material 44 is fed into the manufacturing machine assembly 20 at Section A. A plurality of guide rollers 46 guide the continuous sheet of material 44 through each of the sections of the manufacturing machine assembly 20. The continuous sheet of material 44 comprises a multi-layered structure having a plurality of layers. The continuous sheet of material 44 is typically rolled and mounted to a rotating shaft 48 before the initial printing station 24 of Section A. However, it is to be appreciated that the continuous sheet of material 44 may also be supplied in a flat format without deviating from the subject invention. The continuous sheet of material 44 includes a stock layer 50 having an inner surface 52 and an outer surface 54 spaced from and opposite the inner surface 52. The continuous sheet of material 44 further includes a liner 56 having an interior surface 58 and an exterior surface 60 spaced from and opposite the interior surface 58. An adhesive layer 62 is disposed between the stock layer 50 and the liner 56 for adhesively bonding the stock layer 50 and the liner 56 to one another. Specifically, the adhesive layer 62 is disposed between the inner surface 52 of the stock layer 50 and the interior surface 58 of the liner 56. The stock layer 50, the adhesive layer 62, and the liner 56 are shown in a spaced apart relationship in FIG. 2. For illustrative purposes, the relative sizes of the stock layer 50, the adhesive layer 62, and the liner 56 are exaggerated. The outer surface 54 of the stock layer 50 is further defined as a top side of the continuous sheet of material 44 and the exterior surface 60 of the liner 56 is further defined as a bottom side of the continuous sheet of material 44. The liner 56 further includes a silicone finish (not shown) disposed on the interior surface 58 which allows the liner 56 to be removed from the adhesive layer 62 without removing any of the adhesive layer 62 or damaging the stock layer 50 when the liner 56 is removed. The silicone finish may include, but is not limited to, polydimethylsiloxanes, organopolysiloxanes, and the like. The continuous sheet of material 44 is oriented such that the exterior surface 60 of the liner 56 is facing upward when the continuous sheet of material 44 is fed into the manufacturing machine assembly 20. In other words the continuous sheet of material 44 is fed into the manufacturing machine assembly 20 with the liner 56 on top of the continuous sheet of material 44 and with the stock layer 50 on bottom of the continuous sheet of material 44.

Each of the stock layer 50 and/or the liner 56 may be formed of a paper material, such as paperboard, cardboard, cardstock, fiberboard, tag material and combinations thereof, or the like. Alternatively, the stock layer 50 and/or the liner 56 may be formed from a synthetic material, such as a polyester (PET) material, a semi-gloss material, and/or any other suitable material(s). Preferably, the liner 56 is formed of a 1.5 millimeter clear polyester silicone material.

A support frame 64 is provided for supporting the continuous sheet of material 44 as the sheet of material moves through the manufacturing machine assembly 20. The support frame 64 may be of any size and shape. Each of the stations of the separate sections are coupled to the support frame 64.

The forming of the individual two-sided coupon cards 22 from the continuous sheet of material 44 is now discussed in grater detail with reference to the Figures. Referring to FIG. 1A, the continuous sheet of material 44 is fed into the manufacturing machine assembly 20 before Section A of the manufacturing machine assembly 20 with the exterior surface 60 facing upward. The initial printing station 24 can print indicia onto the exterior surface 60 of the liner 56. Commonly printed indicia can include appropriate logo(s) and/or word(s) which may include manufacturing, marketing, charity information, and the like. This initial print station of Section A is optional and is used to convey temporarily hidden messages as will be discussed in greater detail below. If the initial printing station 24 is utilized, the indicia is typically printed on the exterior surface 60 in a reversed format such that it may be read from the interior side of the liner 56 opposite the exterior surface 60.

The continuous sheet of material 44 is then fed into section B, which includes the application station 26. The application station 26 applies a masking agent 66 to at least a portion of the exterior surface 60 of the release liner 56. If the initial printing station 24 is utilized, then the masking agent 66 will be applied over the printed indicia printed by the initial printing station 24. Preferably, as shown in FIG. 5, the masking agent 66 is applied to half of the liner 56 as the other half will be removed and discarded as discussed below. Even more preferably, the masking agent 66 is only applied to an area of the release liner 56 that will be subsequently used to support one or more removable coupons. This strategic placement of the masking agent 66 assists in ensuring that each of the individual two-sided coupon cards 22 can be made efficiently and can maintain its structural integrity. The masking agent 66 has similar characteristics as the silicone finish described above but also includes a masking layer that remains attached to the adhesive layer 62 to mask the adhesive layer 62 as will be discussed in greater detail below. The masking agent 66 is further defined as a liquid material and is applied in a liquid form in a similar manner as a printing station. Specifically, the masking agent 66 is applied as thick as one millimeter, but dries to approximately one-half millimeter thick. A suitable masking agent 66 can include a homopolymer and be acquired from Craig Adhesives & Coatings of Newark, N.J., under the product name of CRAIGBOND 3808-A.

The structure of the liner 56 is designed to ensure that the masking agent 66 is not absorbed into the liner 56. Polyester liners are suitable for this purpose as these liners do not absorb the masking agent 66. Alternatively, a paper liner 56 may be used, however the paper liner 56 would first need to be coated with a primer and dried prior to applying the masking agent 66 thereon.

After the masking agent 66 is applied to the exterior surface 60 of the liner 56, the continuous sheet of material 44 travels through a drying station 68 also within Section B. The drying station 68 includes a dryer 70 that dries the masking agent 66 on the exterior surface 60 of the liner 56 at a high rate of speed. Preferably, the dryer 70 is an infra-red (IR) dryer 70 because the masking agent 66 must be dried very quickly as the continuous sheet of material 44 passes through the drying station 68. An air dryer may also be used in conjunction with the IR dryer 70 to expedite the drying time of the masking material. However, the air dryer alone, will most likely not provide quick enough drying. Even more preferably, the IR dryer 70 is of relatively large size having approximately 15 bulbs.

The continuous sheet of material 44 then moves into the first inverting device 28 of section C. One or more of the guide rollers 46 located in sections B and/or C may be Teflon coated to ensure that the masking agent 66 does not stick or adhere to the roller. The first inverting device 28 rotates the continuous sheet of material 44. Preferably, the first inverting device 28 rotates the continuous sheet of material 44 180 degrees such that the outer surface 54 of the stock layer 50 is facing upward. In other words, after the continuous sheet of material 44 passes through the first inverting device 28, the continuous sheet of material 44 is then oriented with the stock layer 50 on top of the continuous sheet of material 44 and with the liner 56 on bottom of the continuous sheet of material 44.

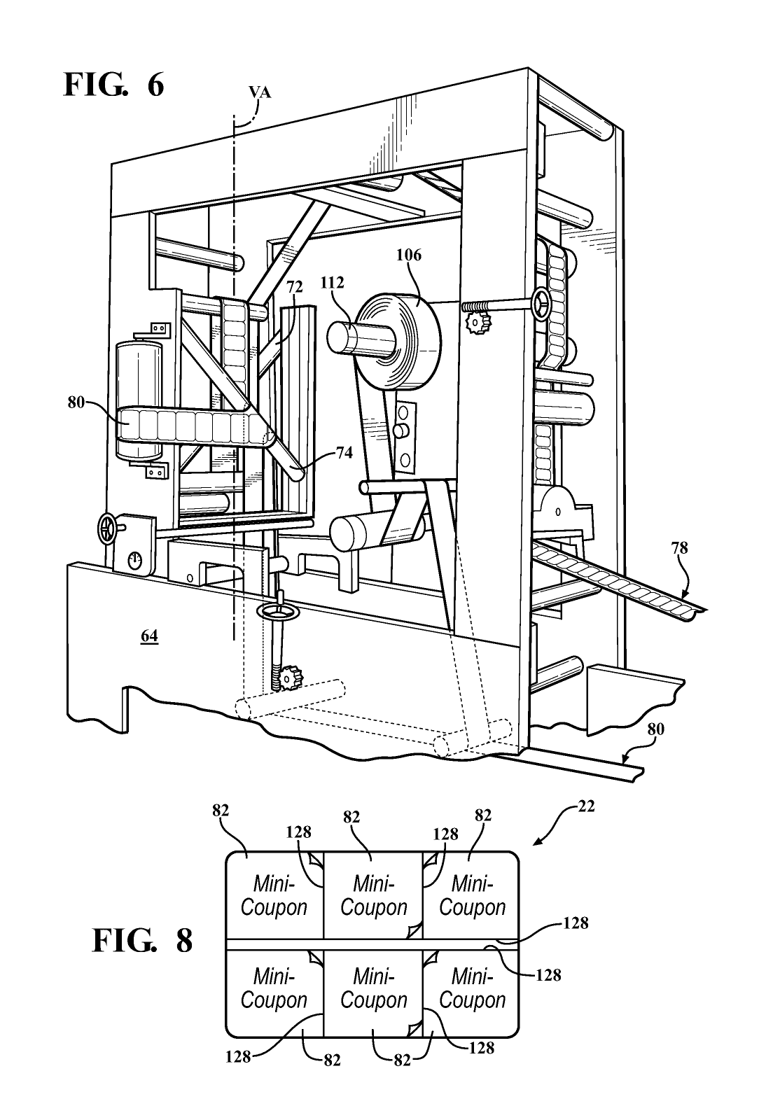

Both the first inverting device 28, shown in FIG. 1A, and the second inverting device 36, shown in FIG. 1B, are substantially similar to one another, and will be described together in detail below. As best shown in FIG. 6, each of the first inverting device 28 and the second inverting device 36 include a first turn bar 72 and a second turn bar 74 oriented in an X-shaped configuration such that the first turn bar 72 overlaps the second turn bar 74 define to define a virtual intersection of the first turn bar 72 and the second turn bar 74. A vertical axis VA passes through the virtual intersection of the first turn bar 72 and the second turn bar 74. In other words, the first turn bar 72 and the second turn bar 74 are spaced from one another but are oriented such that one of the first turn bar 72 and the second turn bar 74 overlies the other second turn bar 74 and the first turn bar 72 to give the appearance of the X-shaped configuration. Preferably, the first turn bar 72 is positioned at a 45 degree angle clockwise with respect to the vertical axis VA and the second turn bar 74 is positioned at a 45 degree angle counter-clockwise with respect to the vertical axis VA. Both the first inverting device 28 and the second inverting device 36 may also include a number of additional bars and/or guide rollers 46 for moving the continuous sheet of material 44 through the first inverting device 28 and the second inverting device 36, respectively.

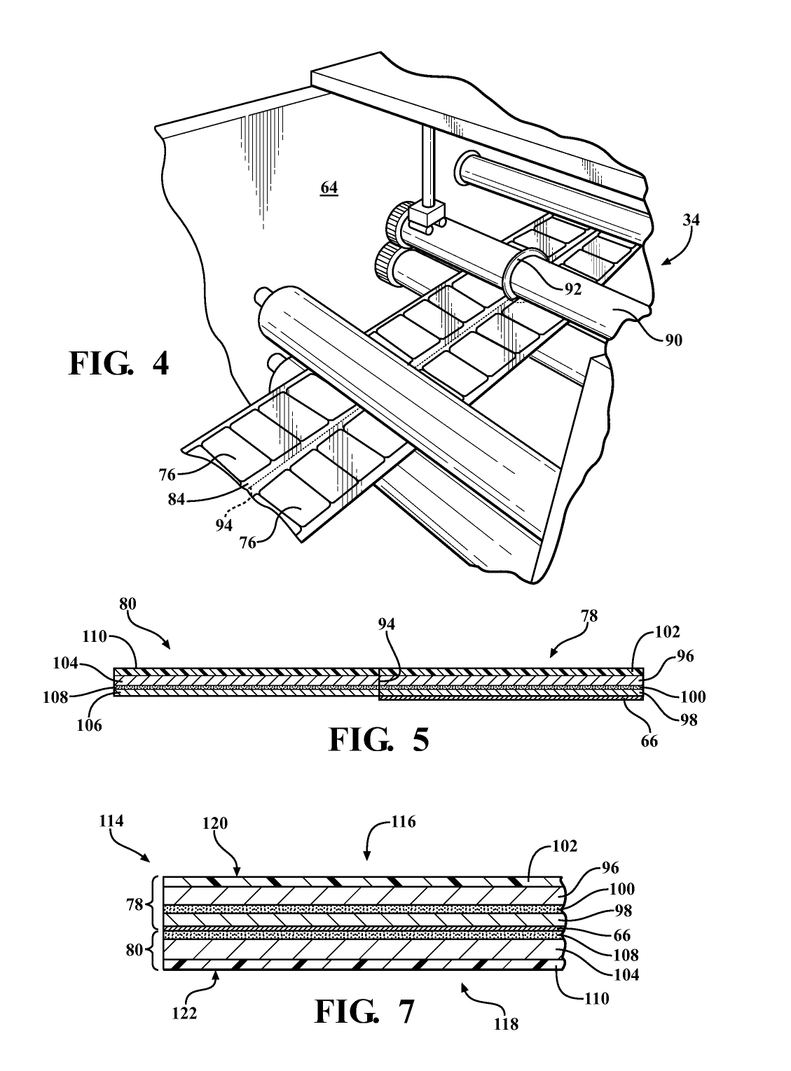

The continuous sheet of material 44 exits the first inverting device 28 with the outer surface 54 of the stock layer 50 facing upward and the exterior surface 60 of the liner 56 facing downward. The continuous sheet of material 44 now moves into the series of primary printing stations 30 in section D. With reference to FIGS. 3 and 4, the primary printing stations 30 print indicia on the outer surface 54 of the stock layer 50 in two parallel rows 76 at the same time. The two parallel rows 76 define a first strip 78 and a second strip 80 of the continuous sheet of material 44. The primary printing stations 30 may utilize a number of Cyrel printing plates (not shown) as known to those skilled in the art. Additionally, variable speed laser printers may also be used as primary printing stations 30 without deviating from the scope of the subject invention. Typically, each of the primary printing stations 30 prints a single color on to the continuous sheet of material 44. Therefore, the number of colors used determines the number of printing plates and/or laser printers required which further determines an overall length of section D. Typically, there will be six or seven printing stations.

The parallel rows 76 define the first strip 78 and the second strip 80 on the sheet of material wherein the first strip 78 and the second strip 80 are continuously moving along a path. More specifically, the path is a longitudinal path that generally runs a lengthwise dimension of the manufacturing machine assembly 20. Commonly printed indicia comprise appropriate logo(s) and/or word(s) which may include manufacturing, marketing, charity information, and the like. The preferred embodiment of the subject invention includes marketing information printed on the first strip 78 and a plurality of mini-coupons 82 and other related information printed on the second strip 80. An unprinted area 84 separates the parallel printed messages on the first strip 78 and the second strip 80, as shown in FIG. 3. As one skilled in the art can appreciate, any type or design of indicia may be printed on either the first strip 78 or the second strip 80 without deviating from the scope of the subject invention. Further, the first strip 78 and the second strip 80 may be of any width as appropriate for a desired application of the individual two-sided coupon cards 22. In the preferred embodiment, the first strip 78 and the second strip 80 are of equal widths. However, it is to be appreciated that the first strip 78 and the second strip 80 may be of unequal widths without deviating from the scope of the subject invention.

After the indicia is printed on to the continuous sheet of material 44 within the primary printing stations 30, the laminating device 32 can apply a laminate 86 to the outer surface 54 of the stock layer 50 for protecting the indicia and for viewing the indicia therethrough, as shown FIG. 1A, specifically in section E. Typically, the laminate 86 is a clear polyester material. However, the laminate 86 may comprise any other suitable material and be of any appropriate color for a desired application. The laminate 86 is typically transparent so as to allow the indicia to be read therethrough. The laminate 86 is generally supplied in a roll and disposed on a laminate shaft 88. The laminate shaft 88 is coupled to the support frame 64 above the path of the continuous sheet of material 44. The laminate 86 protects the outer surface 54 of the stock layer 50 and ensures that the indicia will not smear, rub off, or otherwise be damaged. Application of the laminate 86 is optional.

The continuous sheet of material 44 then moves into section F where the cutting device 34 separates the continuous sheet of material 44 into the first strip 78 and the second strip 80. As best shown in FIG. 4, the cutting device 34 comprises a cutting roller 90 and an annular blade 92 coupled to the cutting roller 90. The sheet of material passes underneath the annular blade 92 wherein the annular blade 92 cuts through the sheet of material along a cutting path 94 within the unprinted area 84, between the first strip 78 and the second strip 80, thereby liberating the first strip 78 and the second strip 80 from each other. As best shown in FIG. 5, the first strip 78 includes a first stock layer 96 and a first liner 98, with a first adhesive layer 100 disposed between the first stock layer 96 and the first liner 98. The masking agent 66 is disposed on the first liner 98. Optionally, the first strip 78 may include a first laminate layer 102 disposed on the first stock layer 96. The second strip 80 includes a second stock layer 104 and a second liner 106, with a second adhesive layer 108 disposed between the second stock layer 104 and the second liner 106. Typically, the second liner 106 is free of the masking agent 66. Optionally, the second strip 80 may include a second laminate layer 110 disposed on the second stock layer 104.

As the first strip 78 and the second strip 80 enter section G, the first strip 78 and the second strip 80 separate from one another. The first strip 78 continues along the longitudinal path and passes over the second strip 80. In other words, the first strip 78 runs the lengthwise dimension of the manufacturing machine assembly 20. The second strip 80 passes into the second inverting device 36. The second inverting device 36 is similar to the first inverting device 28, as described above. However, rather than the entire continuous sheet of material 44 rotating, the second strip 80 rotates relative to the first strip 78 such that the second liner 106 faces the masking agent 66 disposed on the first liner 98. It is to be appreciated that the first strip 78 is not rotated by the second inverting device 36.

Section G also includes the stripping device 38 coupled to the support frame 64 and adjacent the second inverting device 36. The stripping device 38 removes the liner 56 from one of the first strip 78 and the second strip 80 to expose the respective adhesive layer 100, 108. As best shown in FIG. 6, in the preferred embodiment, the stripping device 38 removes the second liner 106 from the second strip 80 to expose the second adhesive layer 108. The second liner 106 is then rolled onto a liner shaft 112 and is later discarded. Preferably, the second liner 106 that is rolled onto the liner shaft 112 does not include the masking agent 66 disposed thereon.

The first strip 78 and the second strip 80 then move into section H of the card manufacturing machine assembly 20. The first strip 78 and the second strip 80 should be aligned both horizontally and longitudinally. In other words, the printed indicia of the first strip 78 should align with the printed indicia of the second strip 80. The coupling rollers 40 and forming rollers 42 of the subject invention are specifically designed to maintain the desired alignment of the first strip 78 and the second strip 80. By maintaining exact alignments, each of the individual two-sided coupon cards 22 will be manufactured in accordance with desired specifications. In other words, each of the individual two-sided coupon cards 22 will have perfectly aligned indicia on both sides thereof.

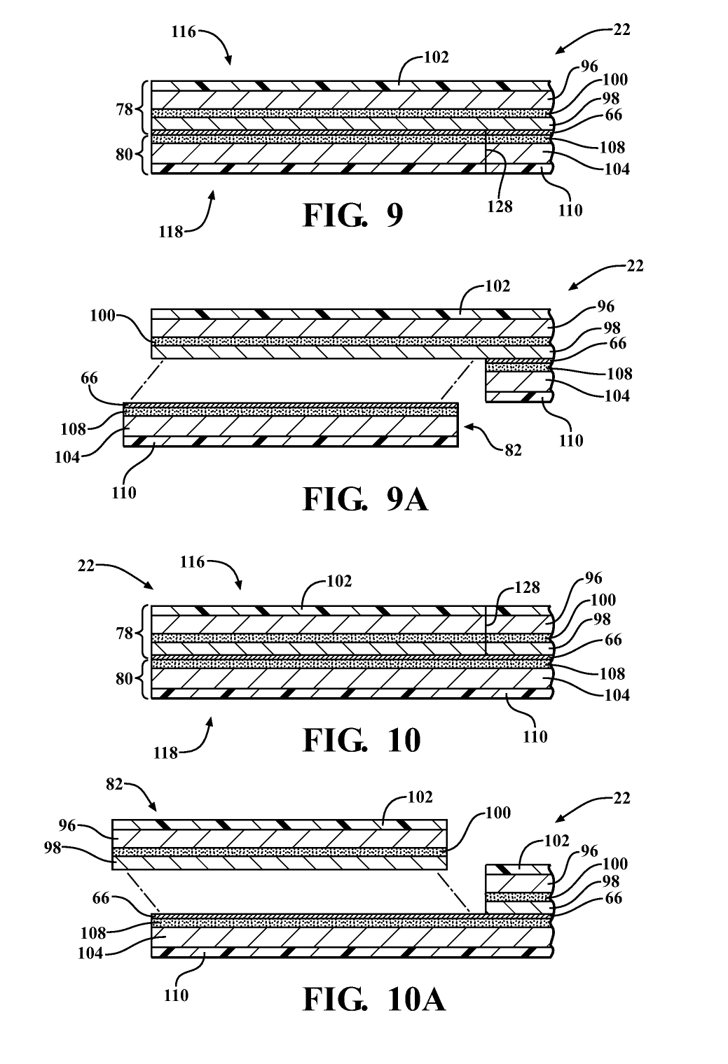

The first strip 78 and the second strip 80 now move into engagement with the coupling rollers 40. Specifically, the coupling rollers 40 move the second adhesive layer 108 of the second strip 80 into a bonded relationship with the masking agent 66 disposed on the first liner 98 of the first strip 78 to mate the first strip 78 and the second strip 80 to one another and form a continuous series of two-sided coupon cards 114 with the indicia printed on both sides thereof. Specifically, the continuous sheet of material 44 comprising the first strip 78 and the second strip 80 as shown in FIGS. 3, 4 and 5 is now converted to the continuous series of two-sided coupon cards 114 as shown in FIGS. 1B, 7, 9, and 10. The first strip 78 is now a first side 116 of the continuous series of two-sided coupon cards 114 and the second strip 80 is now a second side 118 of the continuous series of two-sided coupon cards 114. Specifically, the first laminate layer 102 of the first strip 78 now presents a top surface 120 and the second laminate layer 110 of the second strip 80 now presents a bottom surface 122 of the continuous series of two-sided coupon cards 114. If the first laminate layer 102 and the second laminate layer 110 are omitted, the exterior surface 60 of the first stock layer 96 presents the top surface 120 and the exterior surface 60 of the second stock layer 104 presents the bottom surface 122 of the continuous series of two-sided coupon cards 114. In other words, the first side 116 of the series of two-sided coupon cards includes the marketing information printed thereon, and the second side 118, of the series of two-sided coupon cards, includes the mini-coupons 82 and other related information printed thereon, as shown in FIGS. 9 and 9A. However, it is to be appreciated that the marketing information may be printed on the second side 118 of the series of two-sided coupon cards and the mini-coupons 82 may be printed on the first side 116 of the series of two-sided coupon cards, without deviating from the subject invention, as shown in FIGS. 10 and 10A. This structure creates individual two-sided coupon cards 22, with each having two stock layers, i.e., the first stock layer 96 and the second stock layer 104. One of the first stock layer 96 and the second stock layer 104 may be removed with the mini-coupons 82 and the other of the second stock layer 104 and the first stock layer 96 remains on the individual two-sided coupon cards 22 to provide sufficient rigidity for each of the individual two-sided coupon cards 22 as discussed below.

The structure of the series of two-sided coupon cards includes the first stock layer 96 and the first liner 98 with the first adhesive layer 100 disposed between the first stock layer 96 and the first liner 98. The structure of the series of two-sided coupon cards further includes the second stock layer 104 with the masking agent 66 and the second adhesive layer 108 disposed between the second stock layer 104 and the first liner 98 such that the masking agent 66 continuously masks the second adhesive layer 108. The continuous series of two-sided coupon cards 114 continues along the manufacturing machine assembly 20 and the second side 118 is scored by a scoring wheel 126, as shown in FIG. 1B. The scoring wheel 126 produces score lines 128 in the continuous series of two-sided coupon cards 114, to form a perimeter of the mini-coupons 82. In other words, the scoring wheel 126 scores through multiple layers of the continuous series of two-sided coupon cards 114, including the second stock layer 104, the second adhesive layer 108, and the masking agent 66 to form the perimeter of the mini-coupons 82. The masking agent 66 comprises a gummy material. The gummy material is resilient, and therefore a specialized tooling is required to form the score lines 128 through the masking agent 66. If the laminate 86 was applied by the laminating device 32, the scoring wheel 126 also scores through the second laminate layer 110 disposed on the second stock layer 104. The score lines 128 are substantial enough such that each of the mini-coupons 82 may be removed without affecting the adhesion of any remaining mini-coupons 82 on each of the individual two-sided coupon cards 22. The scoring does not, however, sever through both of the first stock layer 96 and the second stock layer 104. Preferably, the masking agent 66 is only located in the area of the mini-coupons 82. The remaining area of the individual two-sided coupon cards 22 preferably do not include the masking agent 66, which assists in maintaining the structural integrity of the individual two-sided coupon cards 22.

The masking agent 66 defines a first bond, having a first bond strength, with the first liner 98 and the masking agent 66 further defines a second bond, having a second bond strength, with the second adhesive layer 108 when the first strip 78 and the second strip are coupled to one another. The second bond strength is greater than the first bond strength such that the masking agent 66 remains coupled to the second adhesive layer 108 when the mini-coupons 82 are removed from the two-sided coupon cards 22. In other words, the masking agent comes off of the first liner 98 and remains coupled to the second adhesive layer 108 when the mini-coupons 82 are removed. As best shown in FIGS. 8, 9A, and 10A, the mini-coupons 82 may be individually peeled off or otherwise removed from the two-sided coupon cards 22 for redemption. In one embodiment, as shown in FIGS. 9 and 9A, the structure of the mini-coupons 82 includes the second stock layer 104 and the second adhesive layer 108 with the masking agent 66 disposed over the second adhesive layer 108. Alternatively, in another embodiment, as shown in FIGS. 10 and 10A, the structure of the mini-coupons 82 includes the first stock layer 96, the first liner 98, and the first adhesive layer 100 disposed between the first stock layer 96 and the first liner 98. In both embodiments, the masking agent 66 covers or masks the second adhesive layer 108 such that a user does not encounter a tacky surface on either the mini-coupons 82 or on the portion of the individual two-sided coupon cards 22 exposed when the mini-coupons 82 are removed from the individual two-sided coupon cards 22. As such, when the mini-coupons 82 are removed from the individual two-sided coupon cards 22, the mini-coupons 82 are non-tacky. If the initial printing station 24 is utilized, then the indicia printed on the liner will become visible as the mini-coupons 82 are removed from the individual two-sided coupon cards 22.

The continuous series of two-sided coupon cards 114 then moves through the forming rollers 42 in Section H. The forming rollers 42 36 engage the continuous series of two-sided coupon cards 114 and cut completely through the series of two-sided coupon cards to define the individual two-sided coupon cards 22 and a web of scrap material 124. The web of scrap material 124 is removed from the individual two-sided coupon cards 22. The web of scrap material 124 then rolled onto a web shaft 130 and is later discarded. The individual two-sided coupon cards 22 are subsequently accumulate along an exit chute 132 at the end of the manufacturing machine assembly 20.

The present invention has been described herein in an illustrative manner, and it is to be understood that the terminology which has been used is intended to be in the nature of words of description rather than of limitation. Many modifications and variations of the present invention are possible in light of the above teachings. The invention may be practiced otherwise than as specifically described within the scope of the appended claims.

What is claimed is:

1. A manufacturing machine assembly for producing a coupon card fabricated from a continuous sheet of material including a stock layer, a liner, and an adhesive layer disposed between the stock layer and the liner for coupling the stock layer to the liner such that the stock layer defines a top side and the liner defines a bottom side of the continuous sheet of material, and with the continuous sheet of material further including a masking agent, said assembly comprising:
a support frame for supporting the continuous sheet of material as the sheet of material moves through said machine assembly;
an application station coupled to the support frame and receiving the continuous sheet of material with the bottom side facing upwardly for applying the masking agent to at least a portion of the bottom side of the continuous sheet of material;
an inverting device coupled to said support frame and spaced from said application station for rotating and reorienting the continuous sheet of material such that the top side of the continuous sheet material is facing upwardly;
a printing station coupled to said support frame and spaced from said inverting device for printing indicia on the top side of the continuous sheet of material; and
a drying station coupled to said support frame and disposed between said application station and said inverting device for drying the masking agent as the sheet of material moves through said drying station.

2. An assembly as set forth in claim 1 wherein said application station applies the masking agent in a desired pattern on the bottom side of the continuous sheet of material.

3. An assembly as set forth in claim 1 wherein said drying station includes an infra-red dryer coupled to said support frame and spaced from said application station for drying the masking agent.

4. An assembly as set forth in claim 1 wherein said printing station is further defined as a first printing station and further includes a second printing station coupled to said support frame and spaced from said application station.

5. An assembly as set forth in claim 4 wherein said first printing station prints indicia in two parallel rows on the top side of the continuous sheet of material for defining a first strip and a second strip.

6. An assembly as set forth in claim 4 wherein said second printing station prints indicia on the bottom side of the continuous sheet of material.

7. An assembly as set forth in claim 5 further including a cutting device coupled to said support frame and spaced from said first printing station for cutting and separating the continuous sheet of material into the first strip, having a first stock layer, a first adhesive layer and a first liner, and the second strip, having a second stock layer, a second adhesive layer, a second liner, and the masking agent disposed on the second liner.

8. An assembly as set forth in claim 7 wherein said inverting device is further defined as a first inverting device and further includes a second inverting device coupled to said support frame and spaced from said cutting device for rotating the second strip relative to the first strip.

9. An assembly as set forth in claim 8 wherein each of said first inverting device and said second inverting device include a first turn bar and a second turn bar with a vertical axis passing through an intersection of said first and second turn bars and said first turn bar positioned at a 45° angle clockwise with respect to said vertical axis and said second turn bar positioned at a 45° angle counter-clockwise with respect to said vertical axis.

10. An assembly as set forth in claim 8 further including a stripping device coupled to said support frame and spaced from said second inverting device for removing at least a portion of the liner from the second strip and exposing the second adhesive layer of the second strip.

11. An assembly as set forth in claim 10 further including a plurality of coupling rollers coupled to said support frame and spaced from said stripping device for moving the adhesive layer of the second strip into a bonded relationship with the masking agent disposed on the first liner of the first strip and forming a series of two-sided coupon cards with the first strip defining a first side of the coupon cards and the second strip defining a second side of the coupon cards.

12. An assembly as set forth in claim 11 further including a plurality of scoring rollers coupled to said support frame and spaced from said coupling rollers for scoring the second side of the two-sided coupon cards and forming mini-coupons on the coupon cards.

13. An assembly as set forth in claim 12 further including a plurality of forming rollers coupled to said support frame and spaced from said scoring rollers for separating the series of two-sided coupon cards into a plurality of individual two-sided coupon cards and a web of scrap material.

14. An assembly as set forth in claim 1 further including a first laminating station coupled to the support frame and spaced from said first printing station for applying a laminate over the indicia printed on the top side of the continuous sheet of material.

15. A method of manufacturing a coupon card fabricated from a continuous sheet of material including a stock layer having an inner surface and an outer surface, a liner having an interior surface and an exterior surface, and an adhesive layer disposed between the stock layer and the liner for coupling the inner surface of the stock layer to the interior surface of the liner with the continuous sheet of material further including a masking agent, said method comprising the steps of:
orienting the continuous sheet of material such that the exterior surface of the liner is facing upward and the outer surface of the stock layer is facing downward;
applying the masking agent to at least a portion of the exterior surface of the liner;
drying the masking agent;
inverting the continuous sheet of material such that the outer surface of the stock layer is facing upward and the exterior surface of the liner is facing downward;
printing indicia on the outer surface of the stock layer in two parallel rows to define a first strip having a first adhesive layer, and a second strip having a second adhesive layer;
separating the first strip and the second strip;
removing the liner from the second strip to expose the second adhesive layer;
inverting the second strip relative to the first strip such that second adhesive layer faces the masking agent disposed on the liner of the first strip;
mating the second adhesive layer with the masking agent disposed on the liner of the first strip to bond the first strip and the second strip to one another and form a series of two-sided coupon cards such that the first strip defines a first side of the series of two-sided coupon cards and the second strip defines a second side of the series of two-sided coupon cards;
cutting completely through the series of two-sided coupon cards to define individual two-sided coupon cards and a web of scrap stock; and
removing the web of scrap stock from the individual coupons cards.

16. A method as set forth in claim 15 wherein the masking agent is further defined as a liquid material and wherein the step of applying the masking agent is further defined as applying the liquid material.

17. A method as set forth in claim 15 wherein the two-sided coupon cards include a first stock layer, and a liner with the first adhesive disposed between the first stock layer and the liner, and the two-sided coupon cards further including a second stock layer with the masking agent and the second adhesive disposed between the second stock layer and the liner and wherein the step of scoring is further defined as scoring through the first stock layer, the first adhesive layer and the liner to form the mini-coupon such that the masking agent remains on the second adhesive layer with the base portion of the two-sided coupon cards when the mini-coupon is removed.

18. A method as set forth in claim 15 wherein the two-sided coupon cards include a first stock layer, and a liner with the first adhesive disposed between the first stock layer and the liner, and the two-sided coupon cards further including a second stock layer with the masking agent and the second adhesive disposed between the second stock layer and the liner and wherein the step of scoring is further defined as scoring through the second stock layer, the second adhesive layer and the masking agent to form the mini-coupon such that the masking agent remains on the second adhesive layer when the mini-coupon is removed and the liner remains on the base portion of the two-sided coupon cards.

19. A method as set forth in claim 15 further including the step of applying a laminate over the indicia after the step of printing the indicia.
